(19) United States
(12) Patent Application Publication
(10) Pub. No.: US 2024/0292447 A1
(43) Pub. Date: Aug. 29, 2024

(54) CONTROL OF DL AND UL DELAY BASED ON RESOURCE COST

(71) Applicant: Telefonaktiebolaget LM Ericsson (publ), Stockholm (SE)

(72) Inventors: Anders FURUSKÄR, Stockholm (SE); Antzela KOSTA, Solna (SE); Jialu LUN, Solna (SE); Birgitta OLIN, Bromma (SE)

(73) Assignee: Telefonaktiebolaget LM Ericsson (publ), Stockholm (SE)

(21) Appl. No.: 18/573,993

(22) PCT Filed: Jul. 1, 2021
(86) PCT No.: PCT/SE2021/050663

§ 371 Date: Dec. 22, 2023

(51) Int. Cl. H04W 72/542; H04L 43/0864

(52) U.S. Cl. CPC H04W 72/542; H04L 43/0864

(57) ABSTRACT

The present disclosure relates to a method of assigning resources in a communication network (100) for communication between a communication device (103) and a destination node (108) based on communication delay, and a device (101) performing the method. In an aspect, a method of assigning resources in a communication network (100) for communication between a communication device (103) and a destination node (108) based on communication delay is provided. The method comprises acquiring (S101) information indicating different amounts of resources to be assigned for uplink (UL) communication from the communication device (103) to the destination node (108) and for downlink (DL) communication from the destination node (108) to the communication device (103) in order to attain corresponding different communication delays in the UL communication and in the DL communication, selecting (S102), from the acquired information, a combination of UL communication delay and DL communication delay which causes a desired total amount of resources to be assigned for the UL communication and the DL communication while attaining a two-way communication delay being a sum of the UL communication delay and the DL communication delay which complies with a determined delay criteria, and assigning (S103) the amount of resources for the UL communication and for the DL communication corresponding to said desired total amount of resources to be assigned.

### TECHNICAL FIELD

The present disclosure relates to a method of assigning resources in a communication network for communication between a communication device and a destination node based on communication delay, and a device performing the method.

### BACKGROUND

In a communication network, be it a wireless or wired network, or a combination thereof where some sections of a communication link are wired in the form of e.g. copper cable while other sections are deployed by means of wireless communication provided utilizing e.g. Long Term Evolution (LTE) technology, communication link delay is an important parameter to be taken into account when assigning resources for enabling communication over the link.

In today's communication systems, delay is measured or estimated on an uplink and downlink basis. For instance, uplink communication delay from a wireless communication device such as a smart phone, tablet or smart watch, or a wired device such as a gaming console, television set, desktop, etc., to for instance a radio base station (RBS) or Internet-connected server, is measured or estimated, as is downlink communication delay in the opposite direction.

Thereafter, a set of network resources are assigned for enabling uplink communication based on the uplink delay while another set of network resources are assigned for enabling downlink communication based on the downlink delay.

For many delay-sensitive services, such as augmented reality, virtual reality and cloud gaming, total two-way delay is a more adequate resource scheduling parameter. A drawback with utilizing the approach of separate uplink and downlink delay for assigning resources rather than considering two-way delay is that there is a risk that suboptimizations are made.

### SUMMARY

One objective is to solve, or at least mitigate, this problem and thus to provide an improved method of assigning resources in a communication network based on communication delay.

This objective is attained in a first aspect by a method of assigning resources in a communication network for communication between a communication device and a destination node based on communication delay. The method comprising acquiring information indicating different amounts of resources to be assigned for uplink (UL) communication from the communication device to the destination node and for downlink (DL) communication from the destination node to the communication device in order to attain corresponding different communication delays in the UL communication and in the DL communication, selecting, from the acquired information, a combination of UL communication delay and DL communication delay which causes a desired total amount of resources to be assigned for the UL communication and the DL communication while attaining a two-way communication delay being a sum of the UL communication delay and the DL communication delay which complies with a determined delay criteria, and assigning the amount of resources for the UL communication and for the DL communication corresponding to said desired total amount of resources to be assigned.

This objective is attained in a second aspect by a device configured to assign resources in a communication network for communication between a communication device and a destination node based on communication delay, said device comprising a processing unit and a memory, said memory containing instructions executable by said processing unit, whereby the device is operative to acquire information indicating different amounts of resources to be assigned for UL communication from the communication device to the destination node and for DL communication from the destination node to the communication device in order to attain corresponding different communication delays in the UL communication and in the DL communication, to select, from the acquired information, a combination of UL communication delay and DL communication delay which causes a desired total amount of resources to be assigned for the UL communication and the DL communication while attaining a two-way communication delay being a sum of the UL communication delay and the DL communication delay which complies with a determined delay criteria, and to assign the amount of resources for the UL communication and for the DL communication corresponding to said desired total amount of resources to be assigned.

Advantageously, by considering the amount of resources the be assigned to the UL and DL communication, respectively, for attaining a two-delay complying with a given delay criteria, and selecting a desired amount of resources to be assigned to the respective link in order for the sum of delays—i.e. the two-way delay—to comply with the delay criteria, a more efficient use of resources is provided for, resulting in higher network capacity and ultimately a better user experience.

In an embodiment, the total amount of resources to be assigned is computed as a sum of the resources being assigned for UL communication for a particular UL communication delay and the resources being assigned for DL communication for a particular DL communication delay.

In an embodiment, the acquiring of information comprises measuring a plurality of UL communication delays and DL communication delays for different amounts of resources being assigned to the UL communication and the DL communication.

In an embodiment, the method comprises training a machine-learning (ML) model with said acquired information, wherein the selecting of a combination of UL communication delay and DL communication delay comprises supplying the trained ML model with the desired two-way communication delay to be attained, wherein the trained ML model outputs a measure of the amount of resources to be assigned for the UL communication and for the DL communication to attain said desired total amount of resources for the desired two-way communication delay.

In an embodiment, the desired total amount of resources to be assigned being an amount being below a predetermined resource threshold value.

In an embodiment, the desired total amount of resources to be assigned being a lowest total amount.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a wireless communications network in which embodiments may be implemented;

FIG. 2 illustrates a flowchart of a method of assigning resources in the communication network of FIG. 1 according to an embodiment;

FIG. 3a illustrates training of a machine-learning model according to an embodiment;

FIG. 3b illustrates utilization of the trained machine-learning model to determine resource assignment according to an embodiment;

FIG. 4 illustrates a flowchart of a method of assigning resources utilizing machine-learning according to an embodiment;

FIG. 5 illustrates a device according to an embodiment; and

FIG. 6 is a schematic diagram illustrating a telecommunication network connected via an intermediate network to a host computer.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

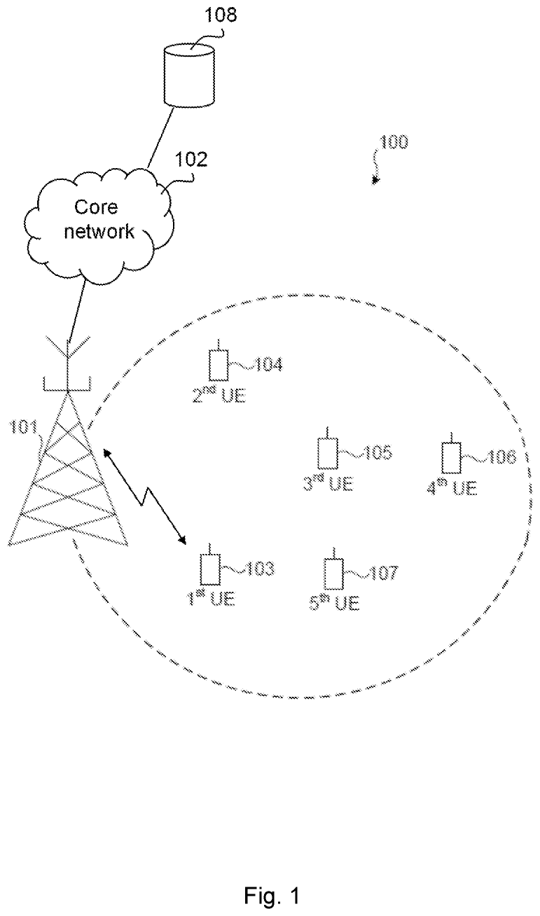

FIG. 1 illustrates a wireless communications network 100 in which embodiments may be implemented. The part of the network comprising a radio base station (RBS) 101 and a group of wireless communication devices 103-107 served by the RBS 101 is commonly referred to as the radio access network (RAN). The wireless communication devices 103-107 are commonly referred to as User Equipment (UE). It is noted that in practice, an RBS may serve hundreds or even thousands of UEs.

In 3^{rd} generation (3G) Universal Mobile Telecommunications System (UMTS), the RBS is typically referred to as a NodeB, in 4th generation (4G) Long Term Evolution, the RBS is typically referred to as an Evolved Node B (eNodeB), while in 5^{th} generation (5G) New Radio (NR), the RBS is typically referred to as a gNodeB (“Next Generation NodeB”) or gNB.

The UEs may be embodied e.g. by smart phones, tablets, gaming consoles, connected vehicles, etc.

As can be seen, first UE 103 communicates wirelessly with the RBS 101, while the RBS 101 typically communicates with core network 102 via wire, whereas backhaul communication between the core network 102 and e.g. an Internet server 108 may either be wired or wireless.

Communication from the first UE 103 via the RBS 101 and the core network 103 to the Internet server 108 is referred to as uplink communication while communication in the opposite direction from the server 108 to the first UE 103 is referred to as downlink communication. In practice, uplink communication is subjected to one delay while downlink communication is subjected to another delay depending on a number of parameters such as network load, UE scheduling, service level agreements (SLAs), etc.

Assuming for instance that a user of the first UE 103 remotely plays a video game hosted at server 108 being a gaming server; it is then important that two-way delay, i.e. total delay taking into account both uplink and downlink, is below a maximum allowable value.

Hence, rather than individually taking into account uplink delay and downlink delay as is commonly done in the art, the total two-way delay is considered. For instance, in an e-gaming application it will typically not matter that the downlink delay is, say, five times that of the uplink delay as long as the total two-way delay does not exceed a predetermined maximum allowable delay. In contrast, implementations in the art typically aim at balancing the delay between the uplink and the downlink such that the delay in the respective link roughly is the same.

A radio network is typically aware of one-way, i.e. downlink or uplink, requirements if at all aware of delay requirements. As such, services with two-way requirements is represented with individual downlink and uplink delays. The RBS 101 will then perform radio resource management (RRM) such as scheduling and link adaptation to try to satisfy the requirements. In order to attain a low (or at least acceptable) delay in any one or both directions, the RBS 101 may have to assign more resources for enabling communication with the desired low delay.

Further, costs in terms of capacity, radio resources, energy consumption, load, etc., for enabling communication having a certain maximum allowable delay may differ for downlink and uplink and may be applicable at different levels, e.g. per service, cell, user, or data frame exchange or a combination thereof. As is understood, for a total uplink or downlink delay, different devices via which uplink and downlink data is transported contribute to a higher or lesser degree to the delay. For instance, for a total uplink delay value, the delay between the UE 103 and the RBS 101 may differ quite substantially from the delay occurring between the RBS 103 and a destination node such as the server 108, the two paths making up the total delay.

Examples include:
A certain service has a higher reliability requirement in uplink. Then, the cost for supporting a lower latency in the uplink is higher than in the downlink.
The amount of data sent in the downlink is greater than that sent in the uplink. The cost of supporting lower latency in the downlink is thus higher than in the uplink.
A cell has a higher load in the uplink. As a result, the cost for supporting a lower latency in the uplink is higher than in the downlink.
A user experiences a poor uplink quality requiring more retransmissions to successfully transmit data. The cost for supporting low latency in the uplink is hence higher (or it is even not possible) than in the downlink.
At a given instant (for a single packet or frame of data), a user may have spent more time in the downlink than required by the one-way delay requirement. Then, for the associated packet or frame sent in response in the uplink, the extra delay can be compensated for by targeting lower uplink delay.

Hence, there are numerous scenarios where it is inefficient to schedule transmission based on separate uplink and downlink delay requirements.

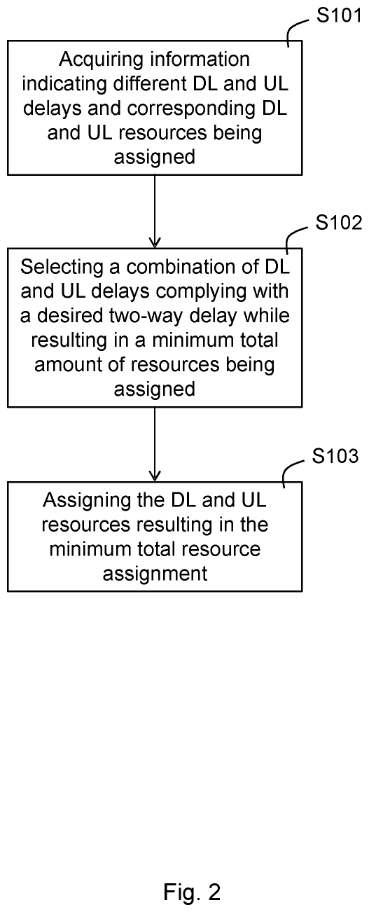

FIG. 2 shows a flowchart illustrating assigning of resources to communication between the first UE 103 and the e-gaming server 108 based on two-way delay according to an embodiment.

In this exemplifying embodiment, the RBS 101 is responsible for scheduling resources for the uplink (UL) and downlink (DL) communication between the first UE 103 and the server 108.

The RBS 101 acquires information indicating UL and DL communication delay between the first UE 103 and the server 108 for different amounts of resources being assigned. As an example, resources to be assigned includes resources relating to time, frequency and power of transmission; e.g. increase/decrease time allocation, bandwidth allocation, power, reduce interference, etc, or a combination thereof.

In one example, the amount of resources being assigned is increased in that transmission power of a particular UE is increased, which generally results in higher transmission quality and thus lower link delay. In another example, the relative amount of resources being assigned to that particular UE is increased by decreasing the amount of resources being assigned to a neighbouring UE. As a result, by decreasing the transmission power of the neighbouring UE, the interference to which said particular UE is subjected is decreased, which generally implies decreased link delay for said particular UE. As is understood, there are numerous types of resources that may be elaborated on for controlling link delay for a particular UE.

Once the amount of resources being assigned are adjusted, measures are taken to control link delay, such as selecting an appropriate modulation and coding scheme (MCS), or Multiple Input Multiple Output (MIMO) mode. Again, there are numerous measures that may be taken for affecting link delay. Controlling the amount of resources being assigned may also include increasing (or decreasing) the amount of assigned resources in the form of e.g. selecting a more powerful MCS, which may lead to a decreased link delay (but more processing resources being consumed).

As is envisaged, the RBS 101 may itself measure the UL and DL communication delay for different amounts of resources being assigned, or may request the information from an appropriate entity (not shown) in the core network 102, such as a Mobility Management Entity (MME) in case of LTE, or an Access and Mobility Management Function (AMF) in case of 5G. Further, the information may be requested from a device specially dedicated for the purpose such as the server 108, or even from a cloud implementation involving a plurality of distributed devices.

Thus, in a first step S101, the RBS 102 acquires information indicating different possible UL and DL communication delays that are attained depending on the amount of resources being assigned for the UL communication and the DL communication, respectively.

The acquired information indicating the amount of resources being assigned to attain a given delay in the respective link is in this exemplifying embodiment specified as:
DL resource assignment: [80, 40, 32, 25, 20] % for [10, 20, 30, 40, 50] ms delay
UL resource assignment: [16, 8, 6.4, 5.0, 4] % for [10, 20, 30, 40, 50] ms delay

As can be seen, in order to attain a DL delay of, say, 10 ms instead of DL delay of 50 ms is associated with a cost in terms of increased resource consumption upon assigning DL resources to the DL communication, in that the amount of DL resources being assigned would have to increase from 20% to 80%, while in order to attain a UL delay of 10 ms instead of a UL delay of 50 ms, the amount of UL resources being assigned would only have to increase from 4% to 16%.

In other words, the RBS 102 acquires information in step S101 indicating different amounts of resources to be assigned for uplink communication from the first UE 103 to the server 108 and for downlink communication from the server 108 to the first UE 103 in order to attain corresponding different communication delays in the uplink communication and in the downlink communication.

To reach a certain delay (with a certain reliability) for UL and DL, respectively, link adaptation is introduced by means of controlling resource assignment for the uplink and downlink. More resources results in lower communication delay and implies that communicated data is more likely to reach its destination with fewer re-transmission. Inevitably, there is a cost in terms of resource consumption for decreasing communication delay.

Assuming that there is a two-way communication delay requirement of 60 ms for this particular e-gaming application; if the two-way delay is any higher, the user experience will not be considered satisfactory. Thus, a determined delay criteria to be complied with for the two-way delay is in this example set to 60 ms.

In step S102, the RBS 102 selects, from the acquired information, a combination of UL communication delay and DL communication delay which causes a lowest total amount of resources to be assigned for the UL communication and the DL communication while attaining a desired two-way communication delay 60 ms, the two-way delay being a sum of the UL delay and the DL delay.

As can be seen in the acquired information illustrated hereinabove, a decrease of the current DL delay from 50 ms to e.g. 20 ms requires a doubling in DL resources being assigned, and the same holds true for the uplink. However, in absolute terms, the resource consumption increases from 20% to 40% in the case of the DL, while in the UL the resource consumption increases from 4% to 8%.

Now, in order to achieve a 60-ms two-way delay in the communication between the first UE 103 and the e-gaming server 108, the sum of the DL communication delay and the UL communication delay cannot exceed 60 ms. As an example, a DL delay of 30 ms in combination with a UL delay 30 ms would attain such goal. In another example, a DL delay of 50 ms in combination with a UL delay of 10 ms would also attain such goal.

However, the method according to the embodiment described with reference to FIG. 2 further advantageously proposes that a “best” combination is determined and then selected upon controlling the delay of the DL and UL, respectively, by means of carefully assigning an adequate amount of resources to the DL and the UL.

In this embodiment, the method strives towards determining how resources should be assigned to the DL and the UL to attain a particular two-way delay while consuming the least possible amount of resources.

To enable a two-way delay of 60 ms, downlink and uplink delays are combined that sum to 60 ms:
DL resource assignment: [80, 40, 32, 25, 20] % for [10, 20, 30, 40, 50] ms delay
UL resource assignment: [4, 5.0, 6.4, 8, 16] % for [50, 40, 30, 20, 10] ms delay

The sum of DL and UL resources being necessary to assign for attaining a two-way delay of 60 ms is thus:
DL and UL resource sum: [84, 45, 38.4, 33, 36] % for 60 ms two-way delay

In this example, the RBS 101 concludes that a DL delay of 40 ms is attained with 25% of the DL resources being assigned, while a UL delay of 20 ms is attained with 8% of the UL resources being assigned. Thus, the minimum total amount of resource being assigned for the DL and UL communication is 33% in order to achieve a two-way delay of 60 ms, which in this case occurs at a DL delay of 40 ms and a UL delay of 20 ms.

Finally, in step S103, the amount of resources corresponding to the minimum total amount of resources being determined. That is, 25% of the resources are assigned in the DL, while 8% of the resources are assigned in the UL, resulting in a two-way delay of 40+20=60 ms.

Advantageously, this provides for more efficient use of resources, resulting in higher network capacity and ultimately a better user experience.

In alternative embodiment, rather than selecting a combination of DL and UL resources to be assigned which results in a lowest total resource assignment (being 33% in the above example), a predetermined resource threshold value may be set to e.g. T=40%, and any resource assignment being below T would be accepted as a desired total resource assignment, which with respect to the above example would result in three different acceptable resources sums, namely 38.4, 33 and 36%.

Thus, if for some reason 25% in DL and 8% UL is not a desirable resource assignment—for instance in a scenario where such resource assignment in DL is considered too high—the RBS 101 may select 20% in DL and 16% in the UL while still attaining a 60-ms two-way delay, thereby complying with the delay criteria of a maximal allowable two-way delay of 60 ms.

In an embodiment, the RBS 101 or any other appropriate device as mentioned above may measure a number of DL and UL communication delays for different amounts of resources being assigned, thereby building a database from which an optimal DL and UL delay combination can be selected given a maximum allowable two-way delay in terms of resource consumption.

In a further embodiment, the measured DL and UL communication delays are supplied to a machine-learning (ML) algorithm along with the corresponding amount of resources being assigned for the respective delay in order to train a model.

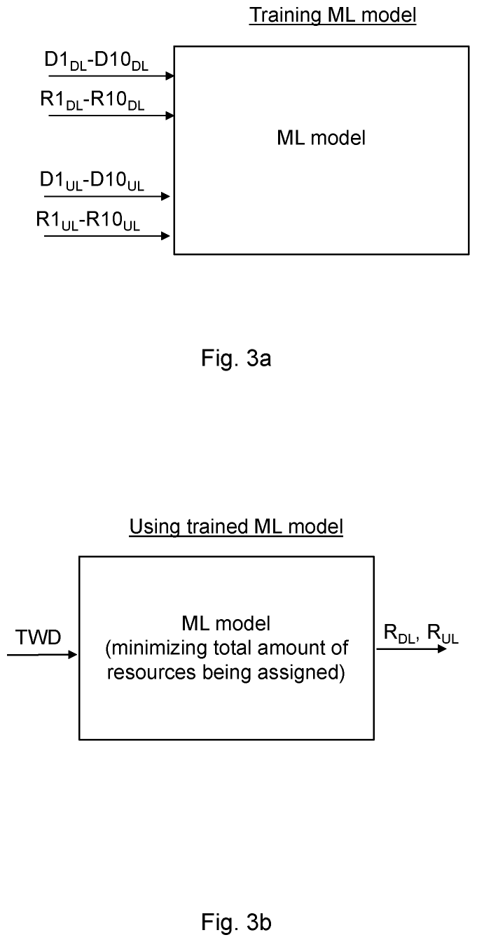

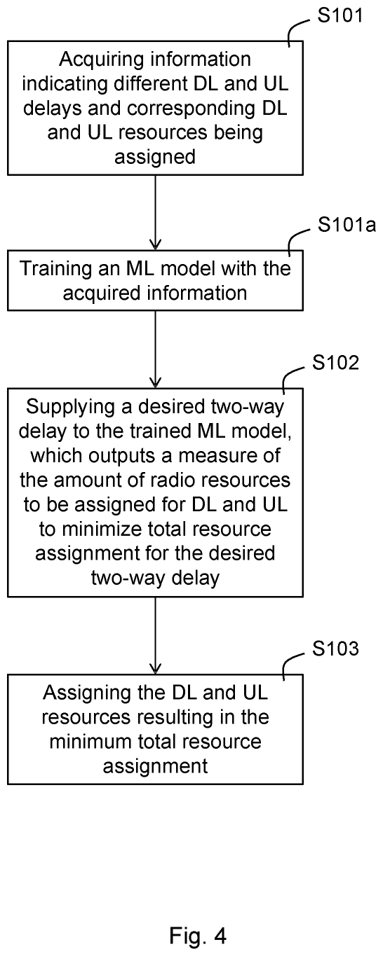

Reference will be made to FIG. 3a illustrating training of an ML model, to FIG. 3b illustrating utilization of the trained ML model to determine a particular amount of resources to be assigned to attain a given delay, and to FIG. 4 illustrating a flowchart of a method of the RBS 101 of assigning resources according to an embodiment.

For instance, with reference to FIG. 3a illustrating training of an ML model according to an embodiment, the RBS 101 trains the ML model to conclude that for a given set of delays in the DL, say D1_{DL}-D10_{DL}, a corresponding set R1_{DL}-R10_{DL} of resources is assigned for the DL, while for a given set of delays in the UL, say D1_{UL}-D10_{UL}, a corresponding set R1_{UL}-R10_{UL} of resources is assigned for the UL. The greater the amount of data being supplied to the ML model, the greater the robustness of the ML model becomes.

FIG. 3b illustrates utilizing the trained ML model of FIG. 3a according to an embodiment to determine the amount of resources R_{DL}, R_{UL} to be assigned in the DL and the UL for a desired two-way delay, TWD, to be attained while selecting the particular combination of DL and UL resources that results in the minimum total amount of resources being assigned, as previously described.

FIG. 4 thus illustrates that after having acquired information indicating different possible UL and DL communication delays that are attained depending on the amount of resources being assigned for the UL communication and the DL communication, respectively, in a first step S101, the RBS 101 trains an ML model with the acquired information in step S101 as illustrated in FIG. 3a.

Thereafter, as previously described in FIG. 3b, the RBS 101 supplies the trained ML model with the desired two-way communication delay to be attained in step 102, wherein the trained ML model outputs a measure of the amount of resources to be assigned for the UL communication and for the DL communication to attain the lowest total amount of resources for the desired two-way communication delay, or at least an amount being below a predetermined resource threshold value T as discussed hereinabove.

In line with the previous example, the trained ML model will on the basis of the information with which it was trained conclude that a DL delay of 40 ms and a UL delay will comply with the TWD requirement of 60 ms while minimizing the total resource utilization to 33%.

Accordingly, in step S103, the DL and UL resource amounts corresponding to the minimal total resource utilization of 33% will be assigned, namely 25% in the DL and 8% in the UL.

As described hereinabove, the device performing the assigning of resources after having determined the two-way delay and corresponding resource consumption is exemplified to be the RBS 101, or alternatively an MME and AMF or a dedicated internet server.

However, in an embodiment, it may be envisaged that the UE 103 itself acquires information regarding UL and DL delays when communicating with the e-gaming server 108 and corresponding resources being assigned. In such embodiment, the resources may be embodied in the form of power output, beamforming configuration, transmission rank, etc., of the UE 103.

In such a scenario, if the delay in either of the directions needs to be modified to comply with two-way requirements, the UE 103 may change the amount of resources being assigned by changing any one or more of these resources.

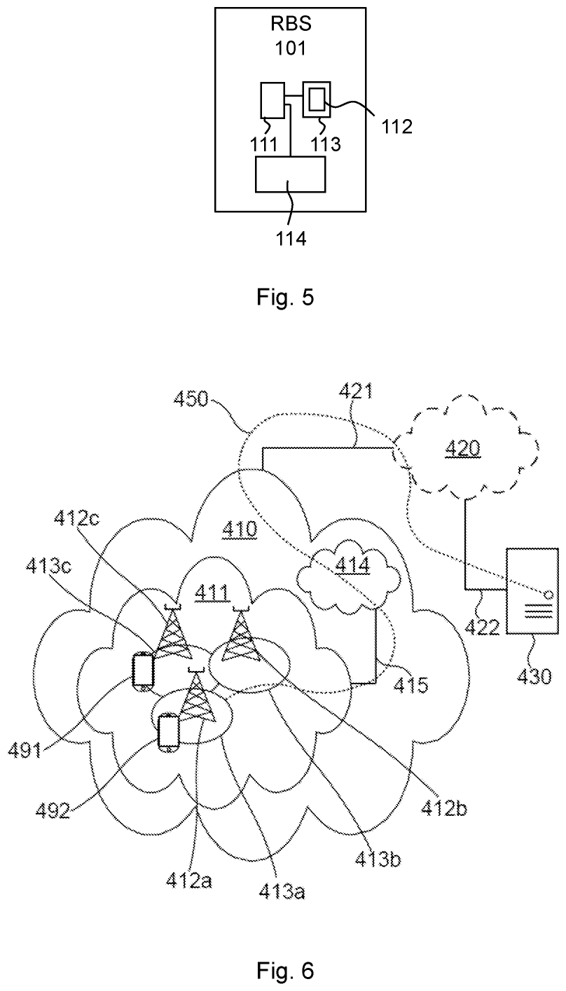

FIG. 5 illustrates a device 101 configured to assign resources in a communication network for communication between a communication device and a destination node based on communication delay according to embodiments, e.g. an RBS, where the steps of the method performed by the RBS 101 in practice are performed by a processing unit 111 embodied in the form of one or more microprocessors arranged to execute a computer program 112 downloaded to a storage medium 113 associated with the microprocessor, such as a Random Access Memory (RAM), a Flash memory or a hard disk drive. The processing unit 111 is arranged to cause the RBS 101 to carry out the method according to embodiments when the appropriate computer program 112 comprising computer-executable instructions is downloaded to the storage medium 113 and executed by the processing unit 111. The storage medium 113 may also be a computer program product comprising the computer program 112. Alternatively, the computer program 112 may be transferred to the storage medium 113 by means of a suitable computer program product, such as a Digital Versatile Disc (DVD) or a memory stick. As a further alternative, the computer program 112 may be downloaded to the storage medium 113 over a network. The processing unit 111 may alternatively be embodied in the form of a digital signal processor (DSP), an application specific integrated circuit (ASIC), a field-programmable gate array (FPGA), a complex programmable logic device (CPLD), etc. The RBS 101 further comprises a communication interface 114 (wired or wireless) over which it is configured to transmit and receive data.

The device 101 of FIG. 5 may be provided as a standalone device or as a part of at least one further device. For example, the device 101 may be provided in a node of a core network, or in an appropriate device of a radio access network (RAN), such as in the RBS 101 itself, in an internet server, etc. Alternatively, functionality of the device 101 may be distributed between at least two devices, or nodes. These at least two nodes, or devices, may either be part of the same network part (such as the core network) or may be spread between at least two such network parts. In general terms, instructions that are required to be performed in real time may be performed in a device, or node, operatively closer to a radio cell than instructions that are not required to be performed in real time.

Thus, a first portion of the instructions performed by the device 101 may be executed in a first device, and a second portion of the of the instructions performed by the device 101 may be executed in a second device; the herein disclosed embodiments are not limited to any particular number of devices on which the instructions performed by the device 101 may be executed.

Hence, the method according to the herein disclosed embodiments are suitable to be performed by a device 101 residing in a cloud computational environment. Therefore, although a single processing circuitry 111 is illustrated in FIG. 5, the processing circuitry 111 may be distributed among a plurality of devices, or nodes. The same applies to the computer program 112. Embodiments may be entirely implemented in a virtualized environment.

FIG. 6 is a schematic diagram illustrating a telecommunication network (such as that schematically illustrated in FIG. 1) connected via an intermediate network 420 to a host computer 430 in accordance with some embodiments. In accordance with an embodiment, a communication system includes telecommunication network 410, such as a 3GPP-type cellular network, which comprises access network 411, such as the RAN discussed in connection to FIG. 1, and core network 414, such as the core network discussed in connection to FIG. 1. Access network 411 comprises a plurality of radio access network nodes 412a, 412b, 412c, such as NBs, eNBs, gNBs (each corresponding to the RBS 101 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown). The method of assigning resources in a communication network for communication between a communication device and a destination node based on communication delay may be performed by the host computer 430, which further may communicate resource assignment decisions to e.g. the radio access network nodes 412a, 412b, 412c, which may execute the decisions to perform the assignments.

The communication system of FIG. 6 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of assigning resources in a communication network for communication between a communication device and a destination node based on communication delay, the method comprising:
acquiring information indicating different amounts of resources to be assigned for uplink (UL) communication from the communication device to the destination node and for downlink (DL) communication from the destination node to the communication device in order to attain corresponding different communication delays in the UL communication and in the DL communication;
selecting, from the acquired information, a combination of UL communication delay and DL communication delay which causes a desired total amount of resources to be assigned for the UL communication and the DL communication while attaining a two-way communication delay being a sum of the UL communication delay and the DL communication delay which complies with a determined delay criteria; and
assigning the amount of resources for the UL communication and for the DL communication corresponding to the desired total amount of resources to be assigned.

2. The method of claim 1, wherein assigning the amount of resources for the UL communication and for the DL communication comprises computing a sum of the resources being assigned for UL communication for a particular UL communication delay and the resources being assigned for DL communication for a particular DL communication delay.

3. The method of claim 1, the acquiring of information comprising:
measuring or estimating UL communication delays and DL communication delays for different amounts of resources being assigned to the UL communication and the DL communication.

4. The method of claim 1, further comprising:
training (DL) a machine-learning (ML) model with the acquired information wherein
the selecting of a combination of UL communication delay and DL communication delay comprises:
supplying the trained ML model with the desired two-way communication delay to be attained, wherein the trained ML model outputs a measure of the amount of resources to be assigned for the UL communication and for the DL communication to attain the desired total amount of resources for the desired two-way communication delay.

5. The method of claim 1, the desired total amount of resources to be assigned being an amount being below a predetermined resource threshold value.

6. The method of claim 1, the desired total amount of resources to be assigned being a lowest total amount.

7. A non-transitory computer readable storage medium storing a computer program comprising computer-executable instructions for causing a device to perform the method of claim 1 when the computer-executable instructions are executed on a processing unit included in the device.

8. (canceled)

9. A device configured to assign resources in a communication network for communication between a communication device and a destination node based on communication delay, the device comprising a processing unit and a memory, the memory containing instructions executable by the processing unit, wherein the device is operative to:
acquire information indicating different amounts of resources to be assigned for uplink (UL) communication from the communication device to the destination node and for downlink (DL) communication from the destination node to the communication device in order to attain corresponding different communication delays in the UL communication and in the DL communication;
select, from the acquired information, a combination of UL communication delay and DL communication delay which causes a desired total amount of resources to be assigned for the UL communication and the DL communication while attaining a two-way communication delay being a sum of the UL communication delay and the DL communication delay which complies with a determined delay criteria; and to
assign the amount of resources for the UL communication and for the DL communication corresponding to the desired total amount of resources to be assigned.

10. The device of claim 9, further being operative to compute the total amount of resources to be assigned as a sum of the resources being assigned for UL communication for a particular UL communication delay and the resources being assigned for DL communication for a particular DL communication delay.

11. The device of claim 9, further being operative to, when acquiring information:
measure or estimate UL communication delays and DL communication delays for different amounts of resources being assigned to the UL communication and the DL communication.

12. The device of claim 9, further being operative to:
train a machine-learning, ML, model with the acquired information; and being operative to, when selecting a combination of UL communication delay and DL communication delay:
supply the trained ML model with the desired two-way communication delay to be attained, wherein the trained ML model outputs a measure of the amount of resources to be assigned for the UL communication and for the DL communication to attain the desired total amount of resources for the desired two-way communication delay.

13. The device of claim 9, the desired total amount of resources to be assigned being an amount being below a predetermined resource threshold value.

14. The device of claim 9, the desired total amount of resources to be assigned being a lowest total amount.
